(19) United States
(12) Patent Application Publication
(10) Pub. No.: US 2013/0086874 A1
(43) Pub. Date: Apr. 11, 2013

(54) Cavitated Polypropylene Films Having Improved Interfacial Adhesion

(71) Applicants: David A. LIESTMAN, Walworth, NY (US); Wayne Robert OSGOOD, JR., Canandaigua, NY (US)

(72) Inventors: David A. LIESTMAN, Walworth, NY (US); Wayne Robert OSGOOD, JR., Canandaigua, NY (US)

(21) Appl. No.: 13/267,365

(22) Filed: Oct. 6, 2011

(51) Int. Cl. B65B 43/04; B29C 55/02; B32B 27/08; B32B 27/32; B32B 5/00

(52) U.S. Cl. 53/455; 428/523; 428/220; 428/516; 264/134

(57) ABSTRACT

Provided is an oriented, opaque polypropylene film, methods of making the oriented, opaque film, and methods of enveloping an article in a VFFS or HFFS unit using the film, the film comprising at least one core layer having a first and second side comprising polypropylene and from 2 wt % to 30 wt % calcium carbonate and from 0.5 wt % to 20 wt % of a whitening agent, each based on the weight of the core layer materials; at least one skin layer adhered to each of the first and second sides of the core layer; wherein the film possesses a density within the range from 0.65 g/cc to 0.88 g/cc and an interfacial adhesion of at least 600 g/inch.

### FIELD OF THE INVENTION

Embodiments disclosed herein are directed to opaque, preferably cavitated, polypropylene films, and more particularly to opaque, cavitated, oriented polypropylene films having improved interfacial adhesion and method of achieving improved interfacial adhesion.

### BACKGROUND

When cavitated film layers are subjected to separation of layer forces (i.e., pulling apart film layers after adhesive has been applied) there is a risk of the films inner structure failing—we call this property interfacial adhesion failure, also called z-tear (z-axis film splitting). When this failure occurs the film has split internally with one or more layers separating from the once intact film structure.

The z-tearing problem of cavitated films is due to the fact that the films' interfacial adhesion, within or between layers, is exceeded by some outside force. During cavitation, voiding occurs as a result of incompatibility of the cavitating agent and the base polymer of the film. The resulting void is larger than the actual incompatible voiding material particle which lowers the overall density of the film. When using a calcium carbonate voiding agent, the interfacial adhesion is weakened substantially. This is a result of the replacement of core polymer by the calcium carbonate (which has a density of about 2.70 g/cc). Increased voiding results in displacing more polymers in the core resulting in a weaker structure.

The inventors present here a solution to this problem by providing an opaque polypropylene film with an optimum balance of CaCO₃ and whitening agent to provide improved interfacial adhesion while still providing an opaque film.

### SUMMARY

In one embodiment is an opaque, cavitated, oriented polypropylene film comprising at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent, each based on the weight of the core layer materials; and at least one skin layer adhered to each of the first and second sides of the core layer; wherein the film possesses a density within the range from 0.65 or 0.66 or 0.67 g/cc to 0.80 or 0.85 or 0.88 g/cc and an interfacial adhesion of at least 600 g/inch.

In another embodiment is a method of imparting opacity to a film comprising combining from 2 or 5 wt % to 15 or 20 or 30 wt % of calcium carbonate, from 0.5 or 1 or 2 or 3 wt % to 8 or 10 or 15 or 20 wt % of a whitening agent, and polypropylene to form core layer composition, each by weight of the core layer composition; forming a core layer of a film from the core layer composition; co-extruding at least one skin layer on the first side of the core layer and a second skin on the second side of the core layer to form the film; and orienting the film in at least the TD or MD direction; wherein the film possesses a density within the range from 0.65 or 0.66 or 0.67 g/cc to 0.80 or 0.85 or 0.88 g/cc and an interfacial adhesion of at least 600 g/inch.

In yet another embodiment is a method of enveloping an article(s) comprising a vertical or horizontal form, fill, and seal apparatus having a drawing means for drawing a roll of film in its machine direction, the film having an adhesive side of the film and a non-adhesive side; unrolling the film with substantially no tear to the non-adhesive side of the film; forming a pouch for receiving the article(s) by applying a force in the transverse direction of the film; placing the article(s) in the pouch; and sealing the pouch to envelope the article(s); wherein the film is oriented in at least one direction as wound in a roll comprising at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent; at least one skin layer adhered to each of the first and second sides of the core layer; wherein the film possesses a density within the range from 0.65 or 0.66 or 0.67 g/cc to 0.80 or 0.85 or 0.88 g/cc and an interfacial adhesion of at least 600 g/inch.

### BRIEF DESCRIPTION OF THE DRAWINGS

FIG. 1 is a graph showing the relationship of the level of CaCO₃ in a film core layer on the interfacial adhesion.

FIG. 2 is a graph showing the relationship between the film density and the interfacial adhesion.

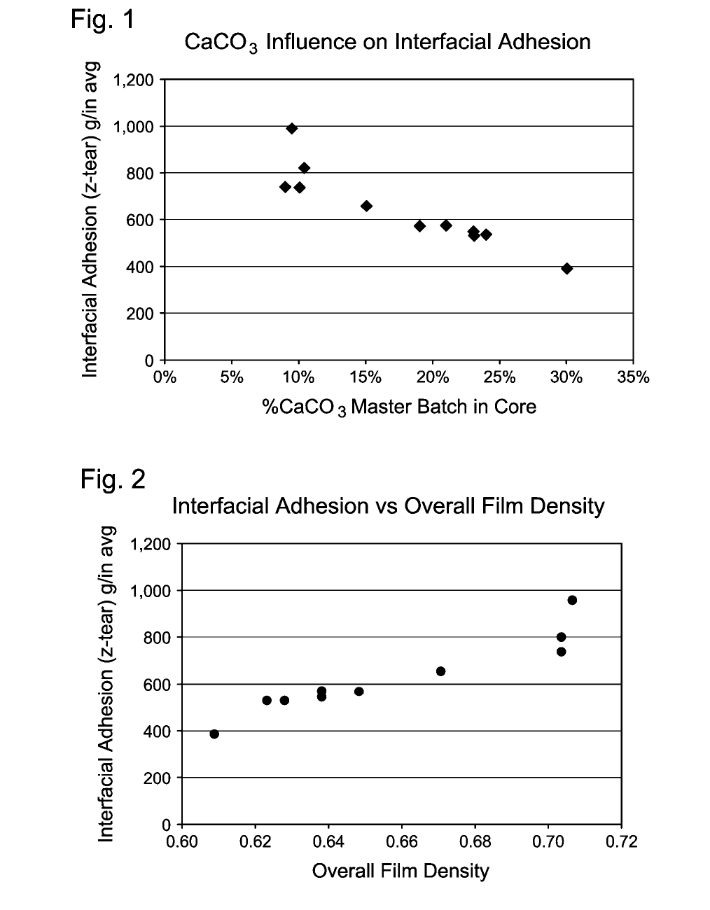

### DETAILED DESCRIPTION

The present invention is directed to cavitated, oriented polypropylene films, and methods of making such films so that they have improved interfacial adhesion. Typically, when voiding agents such as calcium carbonates are used in films, the voided region around the particle is larger than the particle itself and a cavity (void) is formed. Then, when the film is stressed such as by unwinding the film from a roll where adjacent layers of film may adhere to one another, the film may tear in the z-direction, for example, along the cavity formed by the calcium carbonate. The present invention seeks to provide a method of avoiding this by decreasing the amount of calcium carbonate necessary in the film to create an opaque film.

In one aspect is provided a film having desirable properties of improved interfacial adhesion. In certain embodiments, the films described herein possesses an interfacial adhesion of at least 600 g/inch or 620 g/inch or 640 g/inch or 660 g/inch or 700 g/inch or 750 g/inch or 800 g/inch. This is surprising for an opaque, cavitated film. More particularly is provided a cavitated, oriented polypropylene film comprising at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent, each based on the weight of the core layer materials; and at least one skin layer adhered to each of the first and second sides of the core layer, where the skin layers can be the same or different; wherein the film possesses a density within the range from 0.65 or 0.66 or 0.67 g/cc to 0.80 or 0.85 or 0.88 g/cc and an interfacial adhesion of at least 600 g/inch. The “whitening agent” is any material that is capable of imparting opacity to a film of polymer, and in a particular embodiment is titanium dioxide. Furthermore, the films described herein may possess a thickness within the range of from 10 or 20 or 25 or 30 to 50 or 55 or 60 or 70 or 100 μm.

As stated above, the films described herein comprise a core layer that comprises polypropylene along with the whitening agent and calcium carbonate. In certain embodiments, the core layer consists essentially of the polypropylene along with the whitening agent and calcium carbonate, meaning there may be additives present to up to 3 or 5 wt %, by weight of the core layer, as described further herein. The calcium carbonate may be of any desirable particle size, but is preferably within the range from 0.1 or 0.2 or 0.4 or 0.5 μm to 2 or 3 or 4 or 5 μm in average particle size.

The “polypropylene” is a polymer comprising from 60 or 70 or 80 or 85 or 90 or 95 to 100 wt % propylene-derived units (the remainder comprising C₂ and/or C₄ to C₁₀ α-olefin derived units) and can be made by any desirable process using any desirable catalyst as is known in the art, such as a Ziegler-Natta catalyst, a metallocene catalyst, or other single-site catalyst, using solution, slurry, high pressure, or gas phase processes. The polypropylenes have a melting point determined by ASTM D3418 of at least 120° C. or 130° C. or 140° C. or 150° C. or 160° C., or within a range from 120° C. to 150° C. or 160° C. A “highly crystalline” polypropylene is a preferred polypropylene useful in certain embodiments, and is typically isotactic and comprises 100 wt % propylene-derived units (propylene homopolymer) and has a relatively high melting point of from greater than (greater than or equal to) 140° C. or 145° C. or 150° C. or 155° C. or 160° C. or 165° C. as measured by ASTM D3418.

The term “crystalline,” as used herein, characterizes those polymers which possess high degrees of inter- and intra-molecular order. In certain embodiments, the polypropylene has a heat of fusion (H_{f}) greater than 60 J/g or 70 J/g or 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer.

In any case, in certain embodiments, the polypropylene has a melt flow rate (“MFR”, 230° C., 2.16 kg, ASTM D1238) within the range of from 0.1 or 0.5 or 1 to 4 or 6 or 8 or 10 or 12 or 16 or 20 g/10 min. Also, in any case, the polypropylene may have a molecular weight distribution (determined by GPC) of from 1.5 or 2.0 or 2.5 to 3.0 or 3.5 or 4.0 or 5.0 or 6.0 or 8.0. Suitable grades of polypropylene, and in particular, highly crystalline polypropylenes that are useful in oriented films include those made by ExxonMobil, LyondellBasell, Total, Borealis, Japan Polypropylene, Mitsui, and other sources.

In particular embodiments, the films described herein are multi-layered films comprising at least one core layer, and only one in a particular embodiment. For example, the films can be of an A/C/A or A/C/B structure, wherein “C” is the core layer and each of A and B are “skin” layers sandwiching the core layer there between. The skin layers can be the same or different. In yet another embodiment are structures such as A/D/C/D/B, wherein each “D” layer is a “tie-layer” which may be the same or different and typically facilitate the adhesion of the skin layers to the core layer.

In a particular embodiment, the film is a 5-layer film consisting of the core layer sandwiched between a tie-layer on each side, and having a roll-side skin and a bottom-side skin; wherein each tie-layer comprises polypropylene and from 0.5 or 1 or 5 wt % to 14 or 20 wt % whitening agent, the roll-side skin comprises a propylene-ethylene copolymer and the bottom-side skin comprises polyethylene. In particular embodiments, the polypropylene of the tie-layers is a polypropylene homopolymer. And in yet other embodiments, the polyethylene is high density polyethylene (HDPE, density of at least 0.935 g/cc), and the propylene-ethylene copolymer of the roll-side skin comprises from 0.5 wt % to 3 or 4 or 5 wt % ethylene-derived units by weight of the copolymer.

The polymers described herein can be combined in any conventional manner to form the core film layer. As used herein, the term “layer” refers to each of the one or more materials, the same or different, that are secured to one another in the form of a thin sheet or film by any appropriate means such as by an inherent tendency of the materials to adhere to one another, or by inducing the materials to adhere as by a heating, radiative, chemical, or some other appropriate process. The term “layer” is not limited to detectable, discrete materials contacting one another such that a distinct boundary exists between the materials. Preferably, however, the materials used to make one layer of a film will be different (i.e., the weight percent of components, the properties of each component, and/or the identity of the components may differ) from the materials used to make an adjacent, and adhering, layer. The term “layer” includes a finished product having a continuum of materials throughout its thickness.

As mentioned, the core composition can be varied to achieve a desired overall film density and level of cavitation. When present, the other various layers such as tie-layers and/or skin layers are typically co-extruded with the core layer so that they adhere to one another in the desired structures. Methods of co-extrusion are well known in the art and most any method can be used. In certain embodiments, the individual film layers can be pre-formed then adhered to one another. The skin layers can be of a thickness, in certain embodiments, within the range from 0.1 or 0.5 μm to 2 or 3 or 5 μm; the tie-layers may be of a thickness from 2 or 4 μm to 8 or 10 or 15 μm; and the core layer may be from 15 or 17 or 18 μm to 20 or 22 or 24 or 26 μm thickness. In particular, the core layer may be described as having a first and second side, wherein the film further comprises (or consisting essentially of) one or more skin layers adjacent to each of the first and second sides, the skin layers comprising (or consisting essentially of) a polyethylene, a propylene-ethylene-butene terpolymer, or a blend thereof. These compounds are well known in the art.

In some preferred embodiments, the skin layer comprises at least one polymer selected from the group consisting of propylene homopolymers, ethylene-propylene random copolymers, propylene-ethylene random copolymers, propylene-butylene random copolymers, ethylene-propylene-butylene terpolymers, polypropylene plastomers, polyethylene plastomers, LDPE, LLDPE, medium density polyethylene (MDPE), high density polyethylene (HDPE), VLDPE, mLLDPE, ethylene copolymers and terpolymers (including acrylates, esters, and other functional groups), ionomers, polyester, nylon and combinations thereof.

As with the core, the skin layers may further comprise one or more additives, such as pigments, colorants, slip agents, antioxidants, anti-fog agents, anti-static agents, moisture barrier additives, gas barrier additives, and combinations thereof.

The films herein may also be characterized in certain embodiments as being biaxially oriented. The films can be made by any suitable technique known in the art, such as a tentered or blown process, LISIM™, and others. Further, the working conditions, temperature settings, line speeds, etc., will vary depending on the type and the size of the equipment used. Nonetheless, described generally here is one method of making the films described throughout this specification. In a particular embodiment, the films are formed and biaxially oriented using the “tentered” method. In the tentered process, line speeds of greater than 100 m/min to 400 m/min or more, and outputs of greater than 2000 kg/hr to 4000 kg/hr or more are achievable. In the tenter process, sheets/films of the various materials are melt blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 mm to an upper limit of 3 or 4 or 5 or 6 mm. The extruded film is then cooled using air, water, or both. Typically, a single, large diameter roll partially submerged in a water bath, or two large chill rolls set at 20 or 30° C. to 40 or 50 or 60 or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80° C. to 100° C. or 120° C. or 150° C., in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, or cause it to become tacky and adhere to the equipment, but high enough to facilitate the machine direction orientation process. Such temperatures referred to herein refer to the film temperature itself. The film temperature can be measured by using, for example, InfraRed spectroscopy, the source aimed at the film as it is being processed; those skilled in the art will understand that for transparent films, measuring the actual film temperature will not be as precise. In this case, those skilled in the art can estimate the temperature of the film by knowing the temperature of the air or roller immediately adjacent to the film measured by any suitable means. The heating means for the film line may be set at any appropriate level of heating, depending upon the instrument, to achieve the stated film temperatures.

The lengthened and thinned film is cooled and passed to the tenter section of the line for TD orientation. At this point, the edges of the sheet are grasped by mechanical clips on continuous chains and pulled into a long, precisely controlled hot air oven for a pre-heating step. The film temperatures range from 100° C. or 110° C. to 150° C. or 170° C. or 180° C. in the pre-heating step. Again, the temperature will be below that which will melt the film, or cause it to become tacky and adhere to the equipment, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the film temperature is lowered by at least 2° C. but typically no more than 20° C. relative to the pre-heat temperature to maintain the film temperature so that it will not melt the film. After stretching to achieve transverse orientation in the film, the film is then cooled from 5° C. to 10° C. or 15° C. or 20° C. or 30° C. or 40° C. below the stretching temperature, and the clips are released prior to edge trim, optional coronal, printing, and/or other treatment can then take place, followed by winding.

Thus, TD orientation is achieved by the steps of pre-heating the film having been machine oriented, followed by stretching it at a temperature below the pre-heat temperature of the film, and then followed by a cooling step at yet a lower temperature. In one embodiment, the films described herein are formed by imparting a transverse orientation by a process of first pre-heating the film, followed by a decrease in the temperature of the film within the range of from 2° C. or 3° C. to 5° C. to 10° C. or 15° C. or 20° C. relative to the pre-heating temperature while performing transverse orientation of the film, followed by a lowering of the temperature within the range of from 5° C. to 10° C. or 15° C. or 20° C. or 30° C. or 40° C. relative to the stretching temperature, holding or slightly decreasing (by no more than 5%) the amount of stretch, to allow the film to “anneal.” The latter step imparts (reduces or minimizes) the high TD shrink characteristics of the films described herein, thus improving dimensional stability. In certain embodiments, the dimensional stability of the films described herein is within 15% or 10% or 8% at 135° C. after 7 minutes in either the MD or TD as otherwise measured by ASTM D1204. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Aspects of the invention described herein are also directed to a method of imparting opacity to a film, particularly an oriented film. This is achieved by combining a desirable amount of calcium carbonate and whitening agent as determined from disclosure herein. In one embodiment is a method of imparting opacity to a film comprising combining from 2 or 5 wt % to 15 or 20 or 30 wt % of calcium carbonate and from 0.5 or 1 or 2 or 3 wt % to 8 or 10 or 15 or 20 wt % of a whitening agent, and polypropylene to form core layer composition, each by weight of the core layer materials; forming a core layer of a film from the core layer composition; co-extruding at least one skin layer of material on both sides of the core layer to form the film; and orienting the film in at least the TD or MD direction; wherein the film possesses a density within the range from 0.65 or 0.66 or 0.67 g/cc to 0.80 or 0.85 or 0.88 g/cc and an interfacial adhesion of at least 600 g/inch or as described herein.

In a particular embodiment, the film is a 5-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.

In a particular embodiment, the sealed film creates a bag around an article(s) having a length and a width to envelope the article. A “bag” can be in the form of a sack where only one seal is necessary when the film is folded in on itself, or a sock or sleeve where both ends must be heat sealed to envelope the article(s). Desirably, a roll of oriented film, as described above, is provided and film is un-rolled so that at least one layer of film travels through a horizontal or vertical form, fill, and seal apparatus and is first cauterized followed by being heat sealed. As practical, the roll of film may be provided from one location to the location of the form, fill, and seal apparatus having the desired features to carry out the de-orientation method described above. The end result of the process is a bagged article(s) comprising an article(s) enveloped in a bag formed from a film oriented in at least one direction, the bag also having a sealed joint between sections of the film or different films that can be pulled apart by force to facilitate removal of at least part of the article, wherein the film is oriented throughout except for any cauterized areas between the sealed joint and the article(s).

Thus, in a particular embodiment is provided a method of enveloping an article(s) comprising a vertical or horizontal form, fill, and seal apparatus having a drawing means for drawing a roll of film in its machine direction, the film having an adhesive side of the film and a non-adhesive side; unrolling the film with substantially no tear to the non-adhesive side of the film; forming a pouch for receiving the article(s) by applying a force in the transverse direction of the film; placing the article(s) in the pouch; and sealing the pouch to envelope the article(s); wherein the film is oriented in at least one direction as wound in a roll comprising at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent; at least one skin layer adhered to each of the first and second sides of the core layer; wherein the film possesses a density within the range from 0.65 or 0.66 or 0.67 g/cc to 0.80 or 0.85 or 0.88 g/cc and an interfacial adhesion of at least 600 g/inch.

In a particular embodiment, the film is a 5-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.

### EXAMPLES

### Z-Tear Test

The objective is to measure the force required to split the film in the z-axis (through its thickness). This is accomplished through a controlled test environment. This allows for reproducible results. The z-axis force measurement is made with the use of a load cell, adhesive tape, and the film sample. The adhesive tape is attached to the load cell and pulled from the surface of the sample, perpendicular from the film. As the film is separated in the z-axis, the force is recorded. The interfacial adhesion is then reported as an average value as the tape is pulled in grams per inch.

Film Density:

The film density is calculated by measuring the weight of a cut sample, and measuring the thickness (poly gauge thickness/optical gauge thickness) and accounting for the density of polypropylene, the major component, which is assumed to be 0.91 g/cc.

General Procedure:

5-layer films having the polypropylene core layer compositions of various levels of calcium carbonate (50/50 w/w masterbatch of 1.4 μm to 1.5 μm average particle size calcium carbonate in polypropylene) and titanium dioxide were tested for their film density and interfacial adhesion (z-tear). Values of weight percent calcium carbonate in the core are the values of the actual material, taking into account the dilution factor. The films were biaxially oriented polypropylene films of 5-layers A/B/C/D/E, wherein each layer (and its weight percent of layer as a percent of the whole structure) is as follows:
A (3.7%) is an ethylene-propylene copolymer;
B (20.3%) is polypropylene homopolymer with 5 wt % titanium dioxide;
C (47.1%) a core layer made from polypropylene homopolymer/copolymer (9/7) with 5 wt % titanium dioxide and 4.5 wt % to 15 wt % (varying, see Table 1) calcium carbonate;
D (22.5%) is polypropylene homopolymer with 5 wt % titanium dioxide; and
E (6.4%) is HDPE with about 10 wt % of an antiblock.

Having described the various features of the opaque, cavitated, oriented films, described herein in numbered embodiments is:

1. An opaque, cavitated, oriented polypropylene film comprising: at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent, each based on the weight of the core layer materials; and at least one skin layer adhered to each of the first and second sides of the core layer; wherein the film possesses a density within the range from 0.65 or 0.66 or 0.67 g/cc to 0.80 or 0.85 or 0.88 g/cc and an interfacial adhesion of at least 600 g/inch.

2. The film of embodiment 1, wherein the polypropylene has a melting point of at least 120° C. or 130° C. or 140° C. or 150° C.

3. The film of embodiments 1 or 2, wherein the whitening agent is titanium dioxide.

4. The film of any one of the preceding embodiments, wherein the film thickness is within the range of from 20 or 25 or 30 μm to 50 or 55 or 60 or 70 μm.

5. The film of any one of the preceding embodiments, wherein the core layer comprises from 5 wt % to 15 or 20 wt % calcium carbonate by weight of the core layer materials.

6. The film of any one of the preceding embodiments, wherein the core layer comprises from 0.5 or 1 or 2 or 3 wt % to 8 or 10 or 15 or 20 wt % of a whitening agent by weight of the core layer materials.

7. The film of any one of the preceding embodiments, wherein the film possesses a density within the range from 0.66 or 0.67 g/cc to 0.80 g/cc.

8. The film of any one of the preceding embodiments, wherein the film possesses an interfacial adhesion of at least 620 or 640 or 660 or 700 or 750 or 800 g/inch.

9. The film of any one of the preceding embodiments, wherein the film is a S-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.

10. The film of embodiment 9, wherein the polypropylene of the tie-layers is a polypropylene homopolymer.

11. The film of embodiment 9, wherein the polyethylene is HDPE, and the propylene-ethylene copolymer of the roll-side skin comprises from 0.5 wt % to 5 wt % ethylene-derived units by weight of the polymer.

12. A method of imparting opacity to a film of any one of the preceding embodiments comprising: combining from 2 or 5 wt % to 15 or 20 or 30 wt % of calcium carbonate and from 0.5 or 1 or 2 or 3 wt % to 8 or 10 or 15 or 20 wt % of a whitening agent, and polypropylene to form core layer composition, each by weight of the core layer composition; forming a core layer of a film from the core layer composition; co-extruding at least one skin layer on the first side of the core layer and a second skin on the second side of the core layer to form the film; and orienting the film in at least the TD or MD direction; wherein the film possesses a density within the range from 0.65 or 0.66 or 0.67 g/cc to 0.80 or 0.85 or 0.88 g/cc and an interfacial adhesion of at least 600 g/inch.

13. A method of enveloping an article(s) comprising: providing a vertical or horizontal form, fill, and seal apparatus having a drawing means for drawing a roll of film of any one of the preceding numbered embodiments in its machine direction, the film having an adhesive side of the film and a non-adhesive side; unrolling the film with substantially no tear to the non-adhesive side of the film; forming a pouch for receiving the article(s) by applying a force in the transverse direction of the film; placing the article(s) in the pouch; and sealing the pouch to envelope the article(s); wherein the film is oriented in at least one direction as wound in a roll comprising at least one core layer having a first and second side comprising polypropylene and from 2 or 5 wt % to 15 or 20 or 30 wt % calcium carbonate and from 0.5 or 1 or 2 or 3 wt % to 8 or 10 or 15 or 20 wt % of a whitening agent; at least one skin layer adhered to each of the first and second sides of the core layer; wherein the film possesses a density within the range from 0.65 or 0.66 or 0.67 g/cc to 0.80 or 0.85 or 0.88 g/cc and an interfacial adhesion of at least 600 g/inch.

TABLE 1
Test Data for 5-layer film samples

| Sample No. | 1 | 2 | 3 | 4 | 5 | 6 | 7 | 8 | 9 | 10 | 11 |
|---|---|---|---|---|---|---|---|---|---|---|---|
| Overall film density | 0.70 | 0.71 | 0.70 | 0.70 | 0.67 | 0.66 | 0.64 | 0.63 | 0.64 | 0.62 | 0.61 |
| wt % CaCO₃ in core | 4.5 | 4.5 | 5 | 5 | 7.5 | 9.5 | 10.5 | 11.5 | 11.5 | 12 | 15 |
| z-tear, interfacial | 742 | 961 | 738 | 800 | 658 | 573 | 578 | 534 | 551 | 534 | 391 |
| adhesion, g/inch | | | | | | | | | | | |

1. An opaque, cavitated, oriented polypropylene film comprising:
at least one core layer having a first and second side comprising polypropylene and from 2 wt % to 30 wt % calcium carbonate and from 0.5 wt % to 20 wt % of a whitening agent, each based on the weight of the core layer materials; and
at least one skin layer adhered to each of the first and second sides of the core layer;
wherein the film possesses a density within the range from 0.65 g/cc to 0.88 g/cc and an interfacial adhesion of at least 600 g/inch.

2. The film of claim 1, wherein the polypropylene has a melting point of at least 120° C.

3. The film of claim 1, wherein the whitening agent is titanium dioxide.

4. The film of claim 1, wherein the film thickness is within the range of from 20 μm to 70 μm.

5. The film of claim 1, wherein the core layer comprises from 5 wt % to 20 wt % calcium carbonate by weight of the core layer materials.

6. The film of claim 1, wherein the core layer comprises from 1 wt % to 15 wt % of a whitening agent by weight of the core layer materials.

7. The film of claim 1, wherein the film possesses a density within the range from 0.67 g/cc to 0.80 g/cc.

8. The film of claim 1, wherein the film possesses an interfacial adhesion of at least 640 g/inch.

9. The film of claim 1, wherein the film is a 5-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.

10. The film of claim 9, wherein the polypropylene of the tie-layers is a polypropylene homopolymer.

11. The film of claim 9, wherein the polyethylene is HDPE, and the propylene-ethylene copolymer of the roll-side skin comprises from 0.5 wt % to 5 wt % ethylene-derived units by weight of the copolymer.

12. A method of imparting opacity to a film comprising:
combining from 2 wt % to 30 wt % of calcium carbonate and from 0.5 wt % to 20 wt % of a whitening agent, and polypropylene to form a core layer composition, each by weight of the core layer composition;
forming a core layer of a film from the core layer composition;
co-extruding at least one skin layer on the first side of the core layer and a second skin on the second side of the core layer to form the film; and
orienting the film in at least the TD or MD direction;
wherein the film possesses a density within the range from 0.65 g/cc to 0.88 g/cc and an interfacial adhesion of at least 600 g/inch.

13. The method of claim 12, wherein the polypropylene has a melting point of at least 120° C.

14. The method of claim 12, wherein the whitening agent is titanium dioxide.

15. The method of claim 12, wherein the film thickness is within the range of from 20 μm to 70 μm.

16. The method of claim 12, wherein the core layer comprises from 5 wt % to 20 wt % calcium carbonate by weight of the core layer composition.

17. The method of claim 12, wherein the core layer comprises from 1 wt % to 15 wt % of a whitening agent by weight of the core layer composition.

18. The method of claim 12, wherein the film possesses a density within the range from 0.67 g/cc to 0.80 g/cc.

19. The method of claim 12, wherein the film possesses an interfacial adhesion of at least 640 g/inch.

20. The method of claim 12, wherein the film is a 5-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.

21. A method of enveloping an article(s) comprising:
providing a vertical or horizontal form, fill and seal apparatus having a drawing means for drawing a roll of film in its machine direction, the film having an adhesive side of the film and a non-adhesive side;
unrolling the film with substantially no tear to the non-adhesive side of the film;
forming a pouch for receiving the article(s) by applying a force in the transverse direction of the film;
placing the article(s) in the pouch; and
sealing the pouch to envelope the article(s);
wherein the film is oriented in at least one direction as wound in a roll comprising at least one core layer having a first and second side comprising polypropylene and from 2 wt % to 30 wt % calcium carbonate and from 0.5 wt % to 20 wt % of a whitening agent; at least one skin layer adhered to each of the first and second sides of the core layer; wherein the film possesses a density within the range from 0.65 g/cc to 0.88 g/cc and an interfacial adhesion of at least 600 g/inch.

22. The method of claim 21, wherein the polypropylene has a melting point of at least 120° C.

23. The method of claim 21, wherein the core layer comprises from 5 wt % to 20 wt % calcium carbonate by weight of the core layer materials.

24. The method of claim 21, wherein the core layer comprises from 1 wt % to 15 wt % of a whitening agent by weight of the core layer materials.

25. The method of claim 21, wherein the film is a 5-layer film consisting of the core layer sandwiched between a tie-layer on each side, and having a roll-side skin and a bottom-side skin; wherein each tie-layer comprises polypropylene and from 0.5 wt % to 20 wt % whitening agent, the roll-side skin comprises a propylene-ethylene copolymer and the bottom-side skin comprises polyethylene.
